(19) United States
(12) Patent Application Publication
(10) Pub. No.: US 2022/0355928 A1
(43) Pub. Date: Nov. 10, 2022

(54) ATMOSPHERIC ENVIRONMENT-IMPROVING DRONE HAVING LIFE-SAVING AND ADVERTISING FUNCTIONS

(71) Applicant: IVESKY CO., LTD., Busan (KR)

(72) Inventor: Gill Do LEE, Busan (KR)

(73) Assignee: IVESKY CO., LTD., Busan (KR)

(21) Appl. No.: 17/638,685

(22) PCT Filed: Aug. 13, 2020
(86) PCT No.: PCT/KR2020/010773

§ 371 Date: Feb. 25, 2022

(30) Foreign Application Priority Data
Aug. 26, 2019 (KR) 10-2019-0104232

(51) Int. Cl. B64D 1/18; B64C 39/02; B64D 1/22

(52) U.S. Cl. CPC B64D 1/18; B64C 39/024; B64D 1/22; B64C 2201/126; B64C 2201/027

(57) ABSTRACT

The present invention relates to an atmospheric environment-improving drone having life-saving and advertising functions, and more specifically, to a drone configured to move while hovering in the air, the drone comprising: a drone body; and a hovering transport unit for hovering the drone body in the air and moving same. The drone body is provided with a water spray means for purifying the air by adsorbing dust and fine dust in the air. The water spray means includes: support shafts, each of which has one end fixed on the outer surface of the drone body; spray liquid supply pipes fixed to lower portions of the support shafts; and spray liquid spraying nozzles formed at regular intervals on the purified liquid supply pipes. Since the drone configured to move while hovering in the air is used to spray water from the air, the drone can spray a wider area than ground-based water spray devices, thus having the effect of improving the purification efficiency for contaminants or fine dust in the air. Moreover, the drone has an advertising function, and thus can also achieve an advertising effect.

### TECHNICAL FIELD

The present invention relates to an atmospheric environment-improving drone having life-saving and advertising functions, and more particularly, to an atmospheric environment-improving drone having life-saving and advertising functions in which the drone configured to be moved while hovering in the air is used to spray water from the air, so that the water is sprayed in a wider area compared to ground-based water spray devices, thereby having the effect of improving the purification efficiency for contaminants or fine dust in the air, and moreover, having an advertising function and also achieving an advertising effect.

### BACKGROUND ART

In general, scattering dust refers to dust directly exhausted into the atmosphere without going through a predetermined exhaust port at working sites or constructing sites and is called fugitive dust.

The scattering dust generated in the above manner is solid fine particles with a diameter of 0.1 μm to several tens of μm, which is formed by crushing solid materials such as soil, sand, rocks, metals, and plants among particulate matter, and may enter the human body through breathing while floating in the air and be attached to the bronchi and lungs.

In addition, some of the particles may be removed by coughing, sneezing, and ciliary movement, but some may be easily deposited and accumulated in the alveoli or the like. Thus, it is likely to cause greater adverse effects on human health than other air pollutants.

Especially when a person breathes, it is said that fine particles with a diameter of 10 μm or less reach the lungs through the respiratory tract and deposited. Based on this, the scattering dust tends to be added to items for the atmospheric environment standard.

Since the generated amount of dust is increasing as the industries develop and the nature is damaged, the efficient treatment is required from an environmental point of view.

In the related art, water is sprinkled using a sprinkling vehicle or using a sprinkler to remove fine dust or scattering dust from the atmosphere so as to improve the polluted air environment such as fine dust.

However, since the above water sprinkling equipment sprinkles water in the form of a thick water stream such as a general fire hydrant or in the form of a sprinkler, the spraying efficiency is lowered due to the narrow spraying range of water, and the spraying is limited only to the atmosphere close to the ground.

The above-described invention refers to the background of the technical field to which the present invention pertains, and does not mean the prior art.

Among the related art in the technical field to which the present invention pertains, there is Korean Patent Registration No. 0753916.

### DISCLOSURE

### Technical Problem

In order to solve the above problems in the related art, an object of the present invention is to provide an atmospheric environment-improving drone having life-saving and advertising functions, in which the drone configured to be moved while hovering in the air is used to spray water from the air, so that the water is sprayed in a wider area compared to ground-based water spray devices, thereby having the effect of improving the purification efficiency for contaminants or fine dust in the air, and moreover, having an advertising function and also achieving an advertising effect.

### Technical Solution

The present invention provides a drone configured to be moved while hovering in the air and including: a drone body; and a hovering transport unit for hovering and moving the drone body in the air, wherein the drone body is provided with a water spray means for purifying the air by adsorbing dust and fine dust in the air, water spray means includes support shafts each having one end fixed on an outer surface of the drone body, spray liquid supply pipes fixed to lower portions of the support shafts, and spray liquid spraying nozzle s formed at regular intervals on the spray liquid supply pipes.

In addition, the drone body may be further provided on a bottom surface thereof with a floating advertisement means mounted with an advertisement to advertise the advertisement, in which the floating advertisement means may include a connection ring provided on the bottom surface of the drone body, a connection wire member having an upper end portion fixed to the connection ring, fixing rings provided while maintaining predetermined intervals along the connection wire member, an advertisement sheet connected to the fixing ring and having advertisement contents printed on an outer surface thereof, and an advertisement balloon connected to the fixing ring and having advertisement contents printed on an outer surface thereof.

In addition, The drone body may be further provided with the connection wire member, the advertisement sheet connected to the connection wire member, and an elevating advertisement guide means for rotating and elevating the advertisement balloon, wherein the elevating advertisement guide means includes a driving motor formed and driven on the bottom surface of the drone body, an advertisement panel having a top surface fixed to the driving shaft of the driving motor and rotated by the driving of the driving motor, and an elevating motor provided on a bottom surface of the advertisement panel, and having an elevating shaft to which the connection ring connected to the connection wire member is provided, in which a winch motor may be further installed in the drone body, a drum may be provided on a rotary shaft of the winch motor, and a transfer wire may be wound on the drum.

### ADVANTAGEOUS EFFECTS

According to the atmospheric environment-improving drone having life-saving and advertising functions of the present invention, the drone configured to be moved while hovering in the air is used to spray water from the air, so that water can be sprayed in a wider area compared to ground- based water spray devices, thus the drone can have the effect of improving the purification efficiency for contaminants or fine dust in the air, and moreover, the drone can have an advertising function and can also achieve an advertising effect.

### DESCRIPTION OF DRAWINGS

FIG. 1 is a front view showing an atmospheric environment-improving drone having life-saving and advertising functions according to the present invention.

FIG. 2 is a view showing an operating state of the atmospheric environment-improving drone having life-saving and advertising functions according to the present invention.

FIG. 3 is a plan view showing the atmospheric environment-improving drone having life-saving and advertising functions according to the present invention.

FIG. 4 is a partially enlarged view showing the atmospheric environment-improving drone having life-saving and advertising functions according to the present invention.

FIG. 5 a view showing an installation state of

FIG. 6 is a view showing a using state of a floating advertisement unit of the atmospheric environment-improving drone having life-saving and advertising functions according to the present invention.

FIG. 7 is a view showing another embodiment of the atmospheric environment-improving drone having life-saving and advertising functions according to the present invention.

FIG. 8 is a view showing still another embodiment of the atmospheric environment-improving drone having life-saving and advertising functions according to the present invention.

### BEST MODE

### Mode for Invention

Hereinafter, exemplary embodiments of an atmospheric environment-improving drone having life-saving and advertising functions according to the present invention will be described with reference to the accompanying drawings. In the description, thicknesses of lines, sizes of components, and the like shown in the drawings may be exaggerated for clarity and convenience of the description. In addition, the terms described later are defined in consideration of functions in the present invention, and may vary according to the intention or custom of a user or operator. Therefore, the definitions of the terms will be made on the basis of contents throughout the present specification.

In addition, the embodiments of the present invention are not intended to limit the scope of the present invention but merely to provide exemplifications, and there may be various embodiments implemented by the present technical idea.

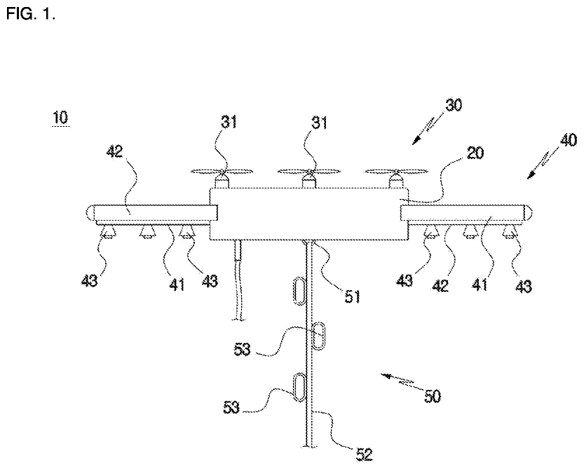

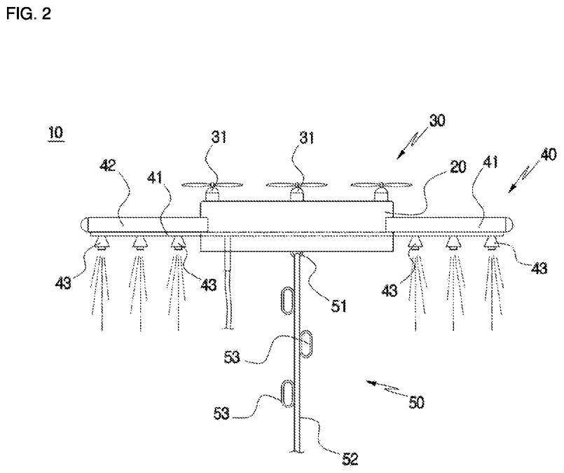

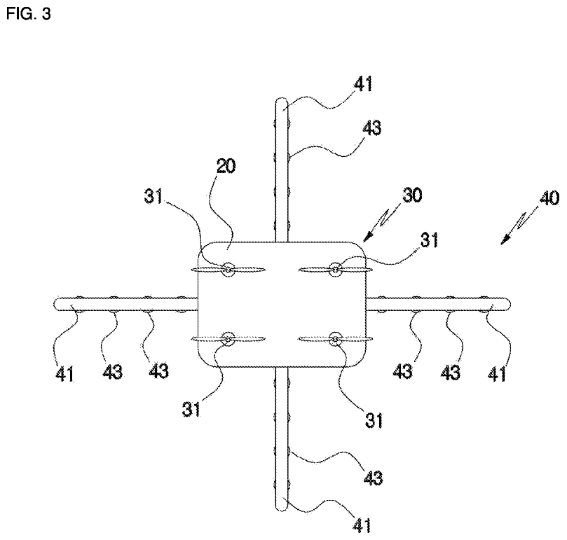

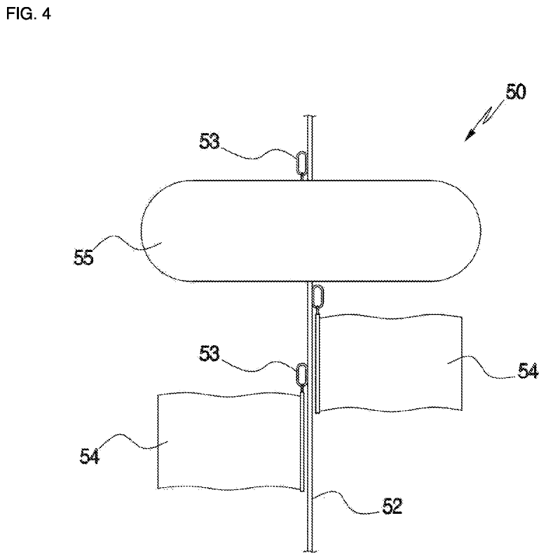

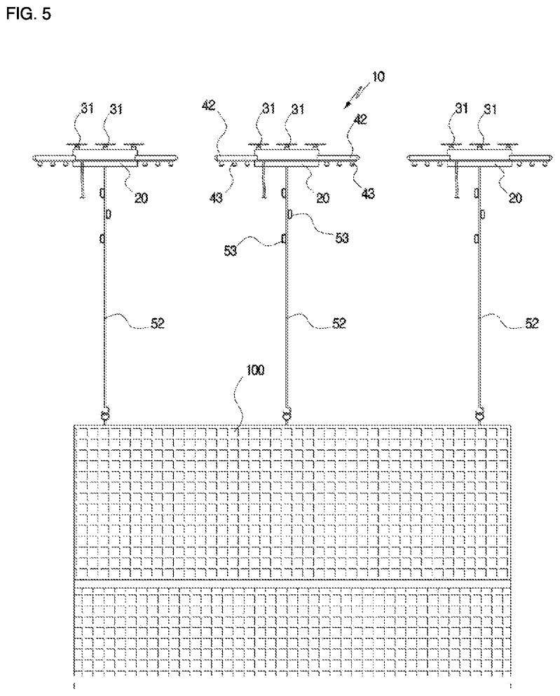

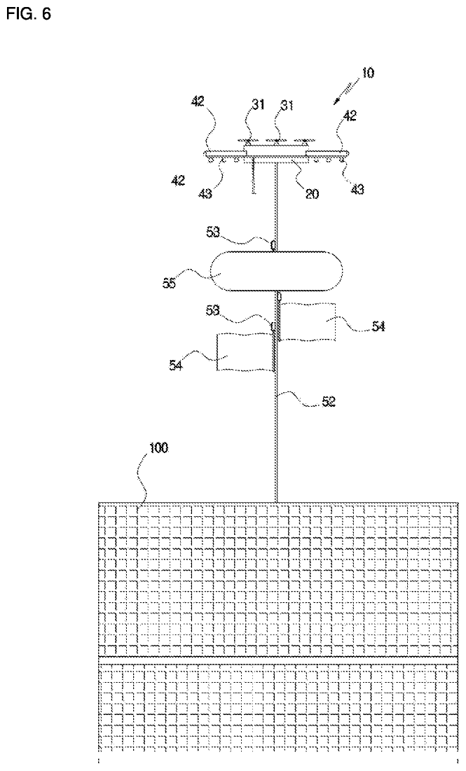

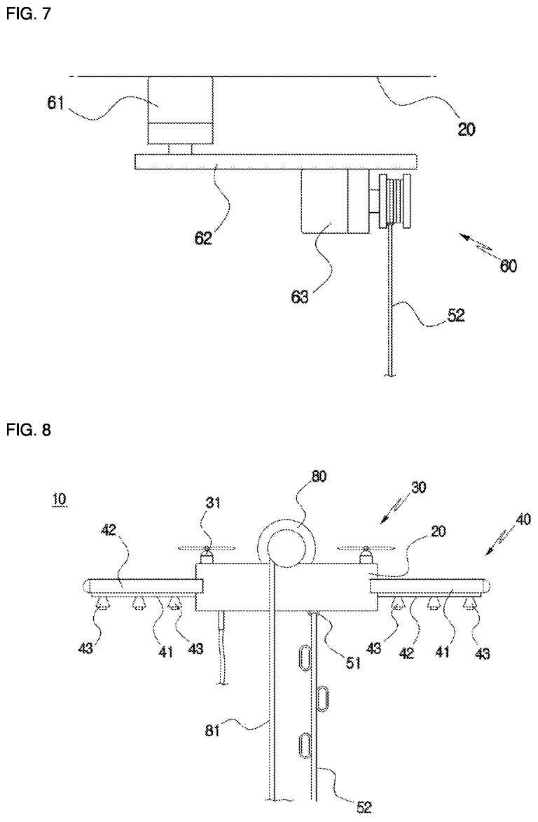

FIG. 1 is a front view showing the atmospheric environment-improving drone having life-saving and advertising functions according to the present invention. FIG. 2 is a view showing an operating state of the atmospheric environment-improving drone having life-saving and advertising functions according to the present invention. FIG. 3 is a plan view showing the atmospheric environment-improving drone having life-saving and advertising functions according to the present invention. FIG. 4 is a partially enlarged view showing the atmospheric environment-improving drone having life- saving and advertising functions according to the present invention. FIG. 5 is a view showing an installation state of the atmospheric environment- improving drone having life-saving and advertising functions according to the present invention. FIG. 6 is a view showing a using state of a floating advertisement unit of the atmospheric environment-improving drone having life-saving and advertising functions according to the present invention. FIG. 7 is a view showing another embodiment of the atmospheric environment-improving drone having life-saving and advertising functions according to the present invention. FIG. 8 is a view showing still another embodiment of the atmospheric environment-improving drone having life-saving and advertising functions according to the present invention.

As shown in the drawings, the atmospheric environment-improving drone 10 having life-saving and advertising functions (hereinafter, for convenience of explanation, referred to as an atmosphere environment-improving drone) according to the present invention refers to a spraying drone 10 configured to purify the air by spraying water while hovering in the air, and the spraying drone 10 includes a drone body 20 and a floating transfer unit 30.

The drone body 20 is formed of a synthetic resin material or a metal material, and has a rectangular housing structure. The drone body 20 may also have a circular or polygonal shape housing structure in addition to the rectangular shape.

Alternatively, the drone body 20 may also have a rectangular, circular or polygonal panel structure, or may have a frame structure.

The hovering transport unit is configured to float and move the drone body 20 in the air. The hovering transport unit includes a hovering motor provided in the drone body 20, and hovering units 31 including hovering blades connected to and rotated about shafts of the hovering motors, respectively. The hovering motor is screwed to an outer surface of the drone body 20 or seated inside an integrally formed protective cap and adhesively fixed thereto, and the hovering blade is fitted and fixed to the shaft of the hovering motor that is disposed outside while passing through the protective cap.

The hovering units 31 are provided on a top portion of the drone body 20 to enable the drone body 20 to hover in the air, and the rotation speed of the hovering blades varies for each hovering unit or each set of hovering units to move the drone body 20.

Four hovering units 31 are provided on the top portion of the drone body 20.

The hovering motor is supplied with electricity by a battery provided inside the drone body 20, and may also be connected to a wire to receive external electricity.

The drone body 20 is provided with a water spray means 40 for purifying the air by adsorbing dust and fine dust in the air, and the water spray means 40 includes support shafts 41 formed of a metal material or synthetic resin material and each having one end fixed on an outer surface of the drone body 20; spray liquid supply pipes 42 screwed and fixed to lower portions of the support shafts 41, and spray liquid spraying nozzles 43 provided at regular intervals on the spray liquid supply pipes to spray water.

The drone body 20 is provided therein with a water tank to be connected to the spray liquid supply pipes 42 so that water is filled, and a pump is installed in the water tank to supply the water to the spray liquid supply pipes 42. Alternatively, a connection hose may be connected to the spray liquid supply pipes so as to be supplied with water from the outside (such as a building 100)

Alternatively, the spray liquid supply pipes 42 may be pipe-connected with a connection pipe formed in a “+” shape, and the connection hose may be connected to the connection pipe, so that water is supplied from the outside.

It is preferable that a guide fan may be further screwed to an end of the spray liquid supply pipes 42 to supply wind in the direction of the ground or building by the guide fan, so that water discharged through the spray liquid spraying nozzles 43 is moved by the wind from the guide fan, thereby preventing the water from being blown outward due to wind blowing from the outside, and increasing the efficiency of water delivery to the ground or building.

In other words, the water spray means includes: support shafts each having one end fixed on an outer surface of the drone body; spray liquid supply pipes fixed to lower portions of the support shafts; spray liquid spraying nozzles formed at regular intervals on the spray liquid supply pipes; and a guide fan installed at the end of the spray liquid supply pipe to move the water discharged through the spray liquid spraying nozzle toward a desired spraying direction while preventing the wind from being blown outward from the desired direction by the wind blowing from the outside, so that the efficiency of water delivery to a building or the ground may be increased.

The drone body 20 is further provided on a bottom surface thereof with a floating advertisement means 50 mounted with an advertisement to advertise the advertisement, in which the floating advertisement means 50 includes a connection ring 51 screwed or attached to the bottom surface of the drone body 20, a connection wire member 52 having an upper end portion tied and fixed to the connection ring 51, fixing rings 53 attached or tied and fixed while maintaining predetermined intervals along the connection wire member 52, an advertisement sheet 54 screwed or attached to the fixing ring 53 and having advertisement contents printed on an outer surface thereof, and an advertisement balloon 55 screwed or attached to the fixing ring 53 and having advertisement contents printed on an outer surface thereof, so as to spray water through the spray liquid spraying nozzle 43, so that fine dust and pollutants in the air may be purified or reduced, and an advertisement may be performed.

It is preferable that a lower end of the connection wire member 52 may be tied and fixed to the fixing ring 53 provided on a roof of the building 100, such that the drone may be placed above the building 100.

The drone body 20 is further provided with the connection wire member 52, the advertisement sheet 54 connected to the connection wire member, and an elevating advertisement guide means 60 for elevating the advertisement balloon 55, in which the elevating advertisement guide means 60 includes a driving motor 61 having one end screwed and fixed to the bottom surface of the drone body 20, an advertisement panel 62 having a top surface screwed and fixed to a driving shaft of the driving motor 61, and screwed and fixed to a bottom surface of the advertisement panel 62, and an elevating motor 63 having an elevating shaft to which the connection ring 51 connected to the connection wire member 52 is welded and fixed, so that the connection wire member 52, the advertisement sheet 54, and the advertisement balloon 55 are rotated or elevated and moved by driving the driving motor 61 and the elevating motor 63, thereby attracting attention to increase the advertising effectiveness.

It is preferable that one end of the advertisement panel 62 may be fixed to the driving shaft of the driving motor 61, and the elevating motor 63 may be fixed to the other end of the advertisement panel 62, so that a rotation radius of the advertisement panel 62 and the elevating motor 63 fixed to be biased are increased, thereby attracting attention to increase the advertising effectiveness, compared to the structure in which the driving shaft is fixed to a center of the top surface of the advertisement panel 62 and the elevation motor 63 is fixed to a center of the bottom surface.

A winch motor 80 may be further screwed and fixed to the top surface of the drone body 20, a drum is provided on a rotary shaft of the winch motor 80, and a transfer wire 81 is wound around the drum to move an end of the transfer wire downward, so that a gas mask or a basket may be connected to the transfer wire and moved in the case of fire.

It is preferable that a vibrator may be further screwed onto the outer surface of the drone body 20, and the vibrator transfers vibration to vibrates the connection wire member 52, the advertisement sheet 54, and the advertisement balloon 55, so that the advertisement sheet 54 and the advertisement balloon 55 are moved by the vibration, thereby increasing the advertising efficiency.

The above-described embodiments of the present invention are merely exemplary, and it will be understood by those skilled in the art that various deformations, modifications and other equivalent embodiments may be applicable based on the above-described embodiments. Therefore, it will be understood that the present invention is not limited to the configurations recited in the above detailed description. Accordingly, the actual scope of the present invention will be defined by the technical spirit of the appended claims. In addition, it is apparent that the present invention is intended to cover all modifications, equivalents and substitutions falling within the spirit and scope of the invention as defined by the appended claims.

[Description of Reference Numerals]

| | |
|---|---|
| 10: Atmospheric environment-improving | 20: Drone body |
| drone | |
| 30: Hovering transport unit | 31: Hovering unit |
| 40: Water spray means | 41: Support shaft |
| 42: Spray liquid supply pipe | 43: Spray liquid spraying |
| | nozzle |
| 50: Floating advertisement means | 51: Connection ring |
| 52: Connection wire member | 53: Fixing ring |
| 54: Advertisement sheet | 55: Advertisement balloon |
| 60: Elevating advertisement guide means | 61: Driving motor |
| 62: Advertisement panel | 63: Elevating motor |
| 80: Winch motor | 81: Transporting wire |
| 100: Building | |

1. An atmospheric environment-improving drone having life-saving and advertising functions and configured to be moved while hovering in an air, the atmospheric environment-improving drone comprising:
a drone body; and
a hovering transport unit for hovering and moving the drone body in the air,
wherein:
the drone body is provided with a water spray mechanism for purifying the air by adsorbing dust and fine dust in the air, in which the water spray mechanism includes:
support shafts each having one end fixed on an outer surface of the drone body,
spray liquid supply pipes fixed to lower portions of the support shafts, and
spray liquid spraying nozzles formed at regular intervals on the spray liquid supply pipes.

2. The atmospheric environment-improving drone of claim 1, wherein the drone body further includes:
a floating advertisement mechanism provided on a bottom surface of the drone body and mounted with an advertisement to advertise the advertisement, in which the floating advertisement mechanism includes:
a connection ring provided on the bottom surface of the drone body,
a connection wire member having an upper end portion fixed to the connection ring,
fixing rings provided while maintaining predetermined intervals along the connection wire member,
an advertisement sheet connected to the fixing ring and having advertisement contents printed on an outer surface thereof, and
an advertisement balloon connected to the fixing ring and having advertisement contents printed on an outer surface thereof.

3. The atmospheric environment-improving drone of claim 2, wherein the drone body further includes:
the connection wire member,
the advertisement sheet connected to the connection wire member, and
an elevating advertisement guide mechanism for rotating and elevating the advertisement balloon, wherein the elevating advertisement guide mechanism includes:
a driving motor formed and driven on the bottom surface of the drone body,
an advertisement panel having a top surface fixed to the driving shaft of the driving motor and rotated by driving of the driving motor, and
an elevating motor provided on a bottom surface of the advertisement panel, and having an elevating shaft to which the connection ring connected to the connection wire member is provided,
wherein a winch motor is further installed in the drone body, a drum is provided on a rotary shaft of the winch motor, and a transfer wire is wound on the drum.
